(19) United States
(12) Patent Application Publication
(10) Pub. No.: US 2024/0167693 A1
(43) Pub. Date: May 23, 2024

(54) PORTABLE RECEPTACLES FOR RESTRAINING LEG MOVEMENT ON A TRIPOD CAMPFIRE GRILL

(71) Applicant: Mark David Garnett, Oakland, MI (US)

(72) Inventor: Mark David Garnett, Oakland, MI (US)

(21) Appl. No.: 18/517,352

(22) Filed: Nov. 22, 2023

Related U.S. Application Data
(60) Provisional application No. 63/427,378, filed on Nov. 22, 2022.

(51) Int. Cl. F24C 15/08

(52) U.S. Cl. CPC F24C 15/08

(57) ABSTRACT

A kit of portable receptacles for restraining leg movement on a tripod campfire grill operatively associated with a raised campfire ring. Each receptacle provides a cavity for receiving the operative distal end of each tripod leg. The underside of the receptacle may provide a plurality of feet for providing a frictional engagement with an upper surface of the raised campfire ring. The kit may provide tripod retainer clips, each retainer clip dimensioned and adapted for restraining an unused portion of a tripod leg to an active portion of the tripod leg.

### CROSS-REFERENCE TO RELATED APPLICATION

This application claims the benefit of priority of U.S. provisional application No. 63/427,378, filed 22 Nov. 2022, the contents of which are herein incorporated by reference.

### BACKGROUND OF THE INVENTION

The present invention relates to campfire grills and, more particularly, to portable receptacles for restraining leg movement on a tripod campfire grill.

Tripod campfire grills are generally designed to rest directly on the ground with their three legs straddling the fire, while a grate hangs from the apex of the tripod over and adjacent to the fire and/or coals. However, when campsites use raised campfire rings the tripod legs are often too short to straddle both the fire and the ring. Users have tried to overcome this problem by precariously resting the tripod legs on top of raised campfire rings. Time and time again this move resulted in an unfortunate accident. The accident happens when the tripod is inadvertently bumped causing one or more tripod legs to fall off the edge of the raised ring. When this happens, the items on the grate likely fall into the fire.

Additionally, many campfire tripods have grates that cannot be sufficiently lowered when their legs sit atop a raised ring. If the tripod legs are composed of several short leg segments, the problem can sometimes be solved by removing one or more segments from each leg. However, if the short leg segments are permanently tethered with an extension spring-like element the user is faced with the problem of what to do with the dangling leg segments. A solution is needed to tidily secure these unwieldly leg segments out of harm's way.

In short, users had three options when using a tripod campfire grills over a raised campfire ring. All three options have serious shortcomings:

First, position the tripod legs outside the raised campfire ring. Often the legs are too short to contact the ground and so the legs precariously straddle the raised ring. When this is the case, the tripod is very unstable. If the legs do contact the ground, the spread of the legs become a tripping hazard to persons near and around the campfire ring.

Second, position the tripod legs inside the raised campfire ring. Placing the legs inside the raised ring, however, exposes the legs to the direct heat of the fire, which may damage the legs. This option also puts the legs at risk of being bumped by the firewood which may cause the items on the grate to fall into the fire.

Third, position the tripod legs directly on top of the raised campfire ring. This option puts the tripod in a very perilous position. If any part of the tripod is inadvertently bumped, one or two legs may fall off the edge of the ring causing the items on the grate to fall into the fire.

As can be seen, there is a need for a set of portable receptacles for restraining leg movement of a tripod campfire grill, thereby providing a user with a portable, simple, and robust system or kit to stabilize a tripod campfire grill on top of a raised campfire ring.

### SUMMARY OF THE INVENTION

The present invention uses portable receptacles to prevent the legs of a tripod campfire grill from falling off the top surface of a raised campfire ring. First, three receptacles are placed, at an approximate equal distance apart, on top of the raised ring. Then the legends of the tripod are placed in the recess of the receptacles. Non-slip feet on the receptacles keep the receptacles firmly planted on the raised ring as a recess in the receptacles cradles the end of the legs to restrict their movement. The present invention includes retainer clips to tidily secure any unused tethered tripod leg segments parallel to and adjacent to their respective active tripod legs.

Previous methods of using tripod campfire grills on top of raised campfire rings are either unstable, prone to dropping the items of the grate into the fire, and/or not portable. The present invention provides a robust solution to stabilize a tripod campfire grill on top of a raised campfire ring that is easily transportable between raised campfire rings.

In one aspect of the present invention, a kit for restraining a tripod along a surface includes the following: three receptacles, each receptacle providing an upper surface communicating with a cavity dimensioned and shaped to receive an operative distal end of a leg of the tripod; and an underside having one or more feet providing frictional engagement with the surface.

In one aspect of the present invention, the kit further includes wherein each foot has a friction coefficient that is greater than one, wherein the underside provides a recess for each foot to protrude from, wherein each foot has a Shore A hardness between 15 and 35, and wherein each foot is configured to withstand at least two-hundred degrees Celsius without melting or combusting; further including: a drain hole communicating a bottom surface of the cavity with the underside; and three leg retainer clips, wherein each leg retainer clip comprises a loop portion and a U-clip portion, wherein each loop portion is dimensioned and shaped to circumscribe the operative distal end comprising an active leg portion and an unused leg portion disposed in a parallel arrangement thereto, wherein the surface is an upper surface of a raised campfire rings, and wherein each body portion is resistance to temperatures found near a campfire.

In yet another aspect of the present invention, a method of restraining a tripod along a surface, the method includes providing the above-mentioned kit and placing the operative distal end of each leg of the tripod in the cavity.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use.

FIG. 2 is a detailed top perspective view of an exemplary embodiment of the present invention.

FIG. 3 is a detailed bottom perspective view of an exemplary embodiment of the present invention.

FIG. 4 is a detailed exploded top perspective view of an exemplary embodiment of the present invention, illustrating an active leg portion 26 and an operatively associated unused leg portion 28 interconnected by a leg tether 27 when the operative end of the tripod leg is inserted in a leg slot 12 of the receptacle 10.

FIG. 5 is a section view of an exemplary embodiment of the present invention, taken along line 5-5 in FIG. 2.

FIG. 6 is a perspective view of an exemplary embodiment of a leg retainer clip 18 of the present invention.

FIG. 7 is a detailed perspective view of FIG. 1, illustrating the leg retainer clip 18 in use.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

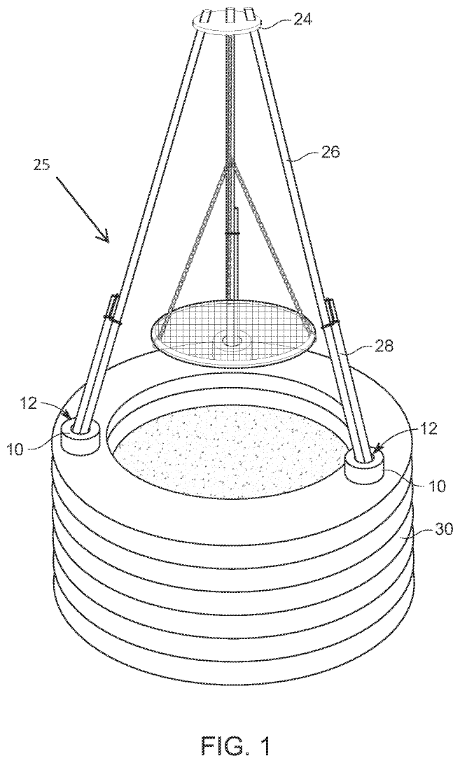

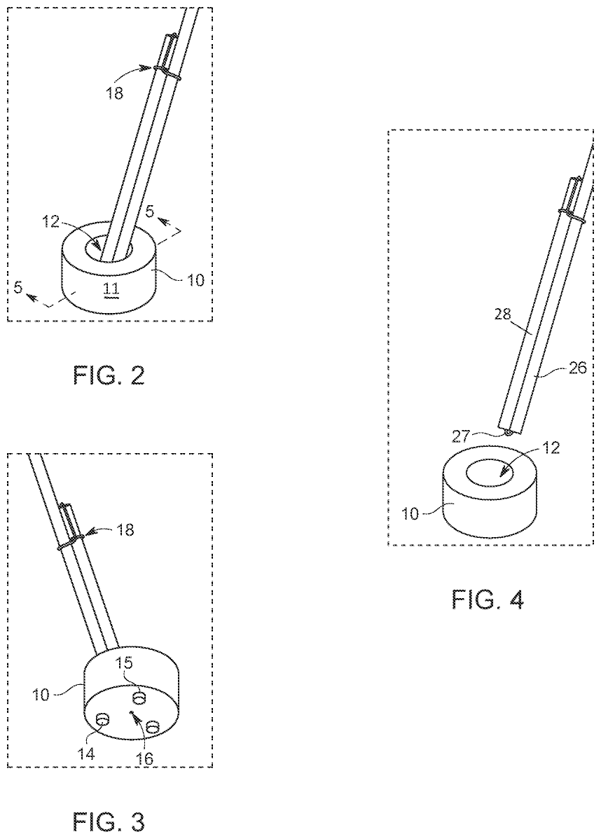

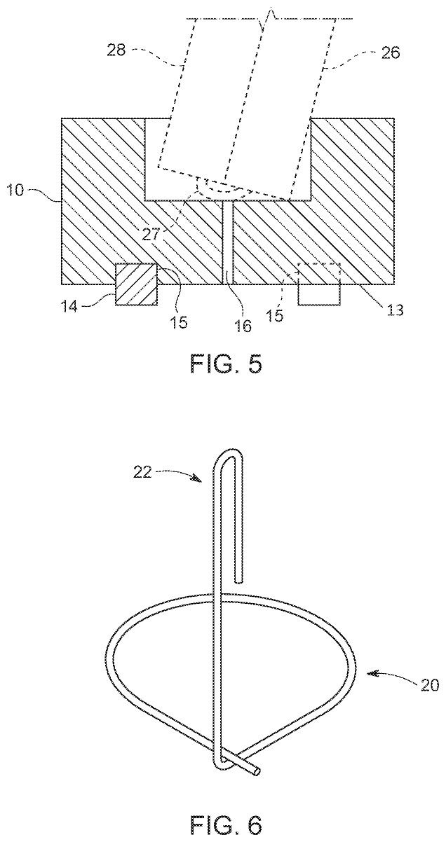

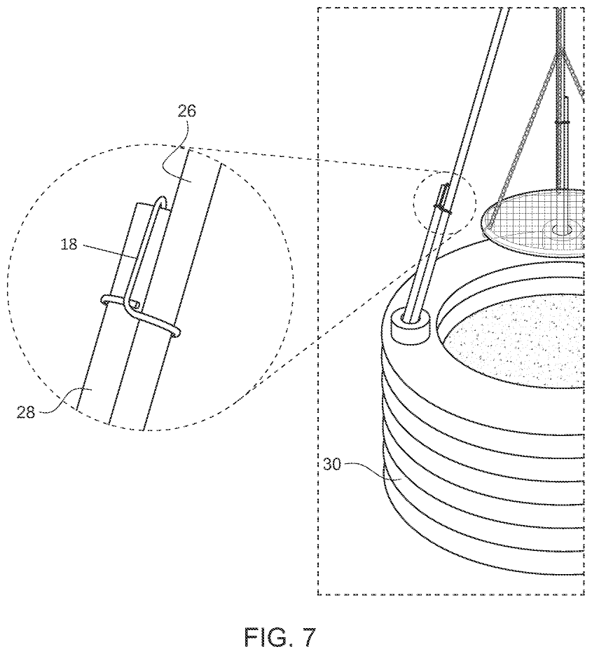

Referring to FIGS. 1 through 7, the present invention provides a set of portable receptacles 10 for restraining leg movement on a tripod campfire grill 24, thereby provided a user with a portable, simple, and robust system or kit to stabilize the tripod campfire grill 24 on top of a raised campfire ring 30.

An exemplary tripod campfire grill 24 may include a portable three-legged frame or stand, used as a platform for supporting a grate and maintaining the stability of the grate as it dangles over a campfire. Each of the three tripod legs 25 may have a first leg portion 26 that extends from an apex of the tripod campfire grill 24 and a second leg portion 28 that extends from a distal end of the first leg portion 26. A tether 27 may interconnect the first and second leg portions 26 and 28 so that the second leg portion 28 may pivot from a coaxial relationship with the first leg portion 26 to a parallel relationship relative to the first leg portion 26, wherein the former increases an overall length of the tripod leg 25. The first leg portion 26 may be referred to as the active leg segment, while the second leg portion 28 may be referred to as the unused leg segment.

The present invention contemplates a plurality of boots or receptacles 10 for the operative ends of the tripod legs 25, one receptacle for each leg 25. Each receptacle 10 may have a body portion 11 that has a cavity 12 along an upper surface thereof. The body portion 11 may be cylindrical in shape, but numerous geometrical and non-geometrical shapes may be used if they enable the functionality disclosed herein. Body portion 11 may be preferably made from concrete or a similar high-density material that is weatherproof and is resistant to the high temperatures found near a campfire.

The lower surface of the body portion 11 may provide a plurality of foot recesses 15, wherein each foot recess 15 is dimensioned and adapted to receive a foot 14 that protrudes from the underside 13 of the body portion 11. It is understood that, alternatively, the plurality of feet 14 may be directly connected to or be integral with said underside 13, thereby obviating the need for foot recesses 15. The feet 14 may be made from high temperature silicone rubber or a similar material that is compliant, has a high friction coefficient (more than one), weatherproof and is resistant to the high temperatures found near a campfire.

A drain hole 16 may communicate the cavity 12 with the underside 13 for allowing moisture to drain from the cavity 12 to the external environment.

The kit or system of the present invention may include a plurality of leg retainer clips 18, each leg retainer clip 18 may have a base ring 20 from which a vertical U-clip normally extends. Each leg retainer clip 18 interconnects the first and second leg portions 26 and 28 together when they are in the parallel relationship. The base ring 20 circumscribes both first and second leg portions 26, 28, much like a lasso, restraining both leg portions 26 and 28 relative to each other, while the U-portion of the U-clip 22 engages the distal end of the second leg portion, as illustrated in FIG. 7. The leg retainer clip 18 is preferably formed from steel wire or similar material that is weatherproof and resistant to the high temperatures found near campfires.

The present invention embodies a kit of three receptacles 10 and three retainer clips 18. The receptacles 10 have a sizeable mass, a low center of gravity, and three widely spaced feet made from a compliant material with a high coefficient of friction. These attributes make the individual receptacles 10 very stable and slip resistant to lateral external forces. By placing one receptacle 10 under each leg 25 of the tripod, the entire tripod becomes very stable and slip resistant to external forces. The retainer clips 18 are used to hold unused tethered tripod leg segments parallel to and adjacent to their respective active legs. When the leg segments 26 and 28 are held in this position, two leg ends are present at each leg recess. For this reason, the width of the leg recesses 12 is sized to accept two leg ends.

The receptacle body portion 11 may be cast in concrete. The mold used to cast the receptacle includes features to form the leg recess, the feet recesses, as well as the drain hole opening 16. The feet 14 are made from high temperature silicone rubber. The feet 14 can be molded to their final shape or cut from a length of extruded cord/rod. The feet 14 may be bonded into the foot recesses 15 with high temperature adhesive. The retainer clips are bent from steel wire.

The drain hole opening 16 is purposed to prevent water from accumulating in the leg recess in the event the receptacles are exposed to rain or snow. Eliminating this feature will not affect the receptacles' ability to securely hold a tripod on top of a raised campfire ring. The retainer clips 18 are optional. The receptacles work with or without the retainer clips. The retainer clips are only used when the user chooses to secure any unused tethered tripod leg 25.

The receptacle body 11 can be reconfigured to eliminate the foot recesses as the feet 14 could be mechanically attached to the receptacle body 11. The feet 14 may be made integral to the receptacle body eliminating the need for assembling the feet 14 to the receptacle body 11. The body 11 could be made from an alternative material such as metal, high temperature resistance rubber, or high temperature resistant plastic. The feet 14 could be made from an alternative material. The three feet 14 could be replaced with one large foot or pad. The three feet could be replaced with four or more feet.

To secure the legs of a tripod campfire grill 10 on top of a raised campfire ring 30, first space the three receptacles at approximately equal distances from one another on the top surface of the raised campfire ring with the feet of the receptacles resting on the top surface of the raised campfire ring. Then, place the ends of three tripod legs 25 into the three leg recesses 12.

If the tripod legs are composed of two or more short leg segments that are permanently connected with an extension spring like tether, the height of the tripod may, in some cases, be lowered by separating out one tripod leg segment for each of the three tripod legs and using the retainer clips to secure the unused leg segments parallel to and adjacent to their respective tethered active legs. To secure an unused leg segment having a hollow cross-section to a tethered active leg, first the unused leg segment is pulled away from the active leg segment(s) by stretching the extension spring like tether. Once the unused leg segment is free to rotate about its tethered end, the unused leg segment is positioned parallel to and adjacent to its tethered active leg. The extension spring-like tether 27 naturally pulls the tethered end of the unused leg segment tight to the tethered end of the active leg. The untethered end of the unused leg segment is secured parallel to and adjacent to the active leg using a retainer clip 18. With the U-shaped portion 22 of the retainer clip leading, the ring portion of the retainer clip is slid over the tethered ends of the unused and active leg segments. Next, the retainer clip is slid along the length of the leg segments until the free end of the U-shaped portion 22 of the leg retainer clip 18 can enter the hollow section of the unused leg segment 28. The leg retainer clip 18 is then slid back towards the tethered end with the free end of the u-shaped portion of the retainer clip sliding into the hollow section of the unused leg segment 28. Once all three unused leg segments 28 have been secured, the tripod is then positioned on top of the three receptacles with the tethered leg ends resting in the three leg recesses.

Additionally, the present invention can be used to restrain leg movement on many applications other than campfire grills. Examples include camera tripods and video tripods. By adding additional receptacles, the invention can also be used with devices having more than three legs, such as quadpods.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A kit for restraining a tripod along a surface, the kit comprising:
three receptacles, each receptacle comprising:
a body portion having a cavity, the cavity dimensioned and shaped to receive an operative distal end of a leg of the tripod; and
an underside of the body portion having one or more feet providing frictional engagement with the surface.

2. The kit of claim 1, wherein each foot has a friction coefficient that is greater than one.

3. The kit of claim 2, wherein the underside provides a recess for each foot to protrude from.

4. The kit of claim 2, further comprising a drain hole communicating a bottom surface of the cavity with the underside.

5. The kit of claim 3, further comprising three leg retainer clips, wherein each leg retainer clip comprises a loop portion and a U-clip portion.

6. The kit of claim 4, wherein each loop portion is dimensioned and shaped to circumscribe the operative distal end comprising an active leg portion and an unused leg portion disposed in a parallel arrangement thereto.

7. The kit of claim 4, wherein the surface is an upper surface of a raised campfire ring.

8. The kit of claim 1, wherein each body portion is resistance to temperatures found near a campfire.

9. The kit of claim 1, wherein each foot has a Shore A hardness between 15 and 35.

10. The kit of claim 1, wherein each foot is configured to withstand at least two-hundred degrees Celsius without melting or combusting.

11. The kit of claim 1, wherein each foot has a friction coefficient that is greater than one, wherein the underside provides a recess for each foot to protrude from, wherein each foot has a Shore A hardness between 15 and 35, and wherein each foot is configured to withstand at least two-hundred degrees Celsius without melting or combusting;
further comprising:
a drain hole communicating a bottom surface of the cavity with the underside; and
three leg retainer clips, wherein each leg retainer clip comprises a loop portion and a U-clip portion, wherein each loop portion is dimensioned and shaped to circumscribe the operative distal end comprising an active leg portion and an unused leg portion disposed in a parallel arrangement thereto,
wherein the surface is an upper surface of a raised campfire rings, and wherein each body portion is resistance to temperatures found near a campfire.

12. A method of restraining a tripod along a surface, the method comprising:
providing the kit of claim 1; and
placing the operative distal end of each leg of the tripod in the cavity.
